(19) United States
(12) Patent Application Publication
(10) Pub. No.: US 2011/0109411 A1
(43) Pub. Date: May 12, 2011

(54) SEALED MAGNETICALLY CONTROLLED ELECTRIC SWITCH ASSEMBLY

(76) Inventor: Wen-Fong LEE, Taichung (TW)

(21) Appl. No.: 12/694,391

(22) Filed: Jan. 27, 2010

(30) Foreign Application Priority Data
Nov. 6, 2009 (TW) 98137867

(51) Int. Cl. H01H 36/00

(52) U.S. Cl. 335/207

(57) ABSTRACT

A sealed magnetically controlled electric switch assembly comprising an electric switch having an on/off operating means, an active magnet means, a follower magnet means, and a sealable insulating housing. The electric switch and the follower magnet means both are sealed in the housing in such a way that the on/off operating means of the switch is coupled with the follower magnet means for motion therewith. The active magnet means is disposed outside the housing in such a way that a resulting magnetic force is formed between the active magnet means and the follower magnet means to switch the on/off operating means of said switch back and forth between the on and off positions.

### BACKGROUND OF THE INVENTION

1. Field of the Invention

The present invention relates generally to electric switches and more particularly to a sealed magnetically controlled electric switch assembly.

2. Description of the Related Art

Sealed switches are useful and often necessary for various applications where the switch needs to be sealed so that corrosives, dust, and other impurities in the atmosphere will not impair operation of the switch or shorten its useful life. Thus, there have been many approaches toward accomplishing the purposes mentioned above, such as, for example, the switches disclosed in U.S. Pat. Nos. 6,008,458, 4,025,885, and 4,015,226. But all of the prior arts share the common disadvantage of having structures that are too complicated to be operated easily or produced cheaply.

### SUMMARY OF THE INVENTION

Accordingly, it is therefore an object of the present invention to provide a sealed magnetically controlled electric switch assembly that works in conjunction with conventional electric switches to not only simplify the mechanism but also reduce the production costs.

It is another object of this invention to provide a sealed magnetically controlled electric switch assembly having a hermetically sealed mechanism so that its operation is not impaired nor its useful life shortened due to corrosives, dust, humidity, and other impurities in the atmosphere.

It is a further object of this invention to provide a sealed magnetically controlled electric switch assembly having a miniature scale for use in household electrical appliances.

These and other objects are further accomplished by a sealed magnetically controlled electric switch assembly comprising an electric switch having an on/off operating means, an active magnet means, a follower magnet means, and a sealable insulating housing. The electric switch and the follower magnet means both are sealed in the housing in such a way that the on/off operating means of the switch is coupled with the follower magnet means for motion therewith. The active magnet means is disposed outside the housing in such a way that a resulting magnetic force is formed between the active magnet means and the follower magnet means to switch the on/off operating means of said switch back and forth between the on and off positions.

### BRIEF DESCRIPTION OF THE DRAWING

The various objects, advantages and novel features of this invention will be more fully apparent from a reading of the following detailed description in conjunction with the accompanying drawings in which like reference numerals refer to like parts, and in which:

FIG. 1 is a side view of a first embodiment according to the present invention;

FIG. 2, a sectional view taken along line 2-2 as shown in FIG. 1, shows all elements of the electric switch assembly in the first position;

FIG. 3, also a sectional view taken along line 2-2 as shown in FIG. 1, shows all elements of the electric switch assembly in the second position;

FIG. 4, a sectional view of a second embodiment of the present invention taken along a line the same as line 2-2 as shown in FIG. 1, shows all elements of the electric switch assembly in the first position;

FIG. 5, a sectional view of a third embodiment of the present invention taken along a line the same as line 2-2 as shown in FIG. 1, shows all elements of the electric switch assembly in the first position;

FIG. 6, also a sectional view of a third embodiment of the present invention taken along a line the same as line 2-2 as shown in FIG. 1, shows all elements of the electric switch assembly in the second position;

FIG. 7, a sectional view of a fourth embodiment of the present invention taken along a line the same as line 2-2 as shown in FIG. 1, shows all elements of the electric switch assembly in the first position; and

FIG. 8 is a sectional view of a fourth embodiment of the present invention taken along line 8-8 as shown in FIG. 7.

### DETAILED DESCRIPTION OF THE INVENTION

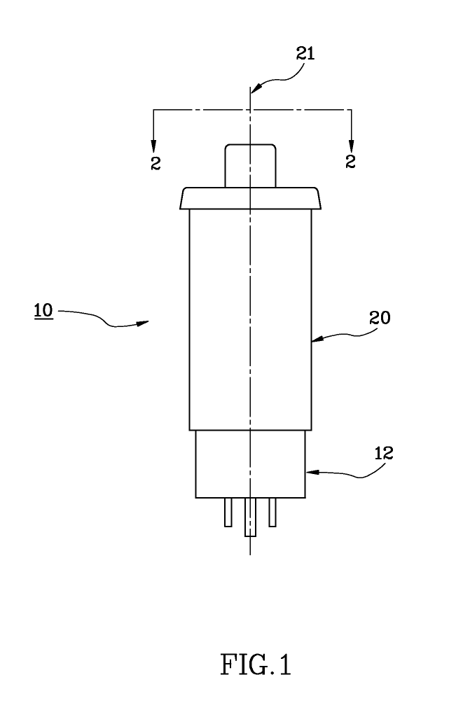

Referring firstly to FIGS. 1, 2 and 3, a sealed magnetically controlled electric switch assembly 10 according to the present invention includes a sealable insulating housing 12, an electric switch 14, a follower magnet means 16, an active magnet means 18 and an insulating cover 20. Housing 12, electric switch 14, magnet means 16 and 18, and cover 20 are disposed about a central axis 21.

Housing 12 has a cylindrical wall 122 with a chamber 124 for receiving electric switch 14 and follower magnet means 16. Electric switch 14 is a conventional pushbutton switch for use in household electrical appliances. An on/off operating means (not shown in the drawings) with a pushbutton 142 is linearly operable along central axis 21 to open and close the switch contacts.

Follower magnet means 16, in this embodiment, has an inner permanent magnet 162 disposed sandwichedly between upper portion 126 of wall 122 of housing 12 and upper side 144 of pushbutton 142 of electric switch 14 such that outer surface 164 with the particular magnetic polarity of inner permanent magnet 162 faces upper portion 126 of wall 122 of housing 12.

Insulating cover 20 has a cylindrical wall 202 with a receiving room 204, an upper bore 206 and an underside opening 208. Housing 12 is partly inserted into room 204 from underside opening 208 so that a space 210 is defined above upper portion 126 of housing 12.

Active magnet means 18, in this embodiment, includes an actuator 22 and an outer permanent magnet 23. Actuator 22 has a disc-shaped body 222 and a post-shaped pusher 224 projecting from the upper end of body 222. Outer permanent magnet 23 is fixed on the bottom end of body 222. Outer permanent magnet 23 has an undersurface 232 with the same particular magnetic polarity as inner permanent magnet 162.

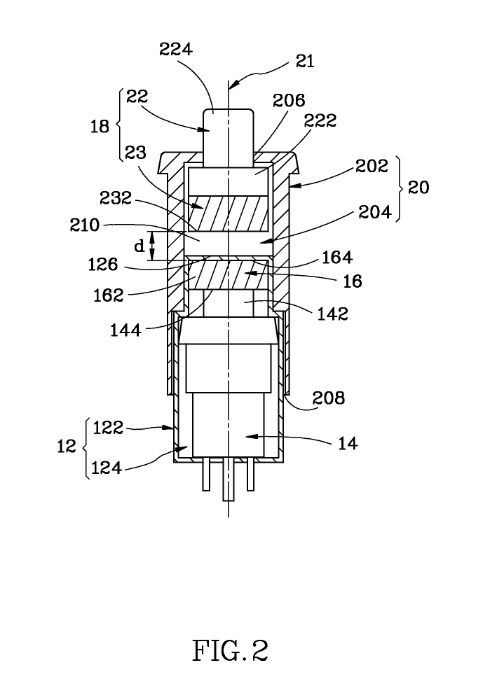

In combination, actuator 22 and outer permanent magnet 23 are received in space 210 in such a way that pusher 224 projects to the outside of cover 20 from upper bore 206 thereof. Undersurface 232 of outer permanent magnet 23 faces upper portion 126 of wall 122 of housing 12 so that when pusher 224 is not in its depressed position, outer permanent magnet 23 and follower magnet means 16 are spaced apart a predetermined distance “d” by the repulsive magnetic forces resulting therebetween, and electric switch 14 is kept in the off or open position. In such an arrangement, as shown in FIG. 2, we say here that all elements of electric switch assembly 10 are in a first position.

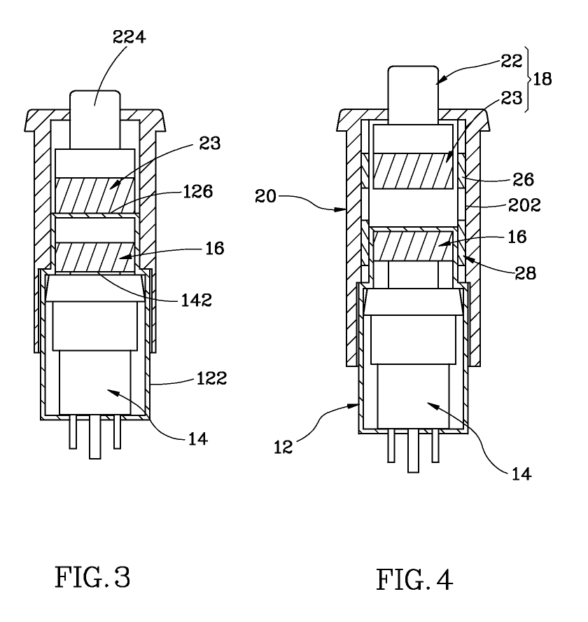

When pusher 224 of actuator 22 is depressed and thereby moved from the first position to a second position, as shown in FIG. 3, outer permanent magnet 23 is simultaneously moved to lean against upper portion 126 of wall 122 of housing 12 so that the resulting magnetic force will cause follower magnet means 16 and pushbutton 142 of switch 14 to move downward synchronously, taking electric switch 14 from the off or open position to the on or closed position.

As the depression force is released, in this embodiment, on/off operating means of switch 14 will force pushbutton 142 thereof back to the off or open position; at the same time, follower magnet means 16 is moved synchronously with pushbutton 142 of switch 14, and the resulting magnetic force will cause active magnet means 18 back to the first position.

Referring to FIG. 4, the sealed magnetically controlled electric switch assembly 10 shown in this drawing is much the same as that shown in FIGS. 2 and 3, except that it further includes a first reinforced positioner 26 and a second reinforced positioner 28. First reinforced positioner 26 is made of paramagnetic materials and disposed on the inner surface of wall 202 of cover 20 near outer permanent magnet 23 of active magnet means 18 to ensure that active magnet means 18 can be kept in the first position by the resulting magnetic force thereof. Second reinforced positioner 28 is also made of paramagnetic materials and disposed on the inner surface of wall 202 of cover 20 but near inner permanent magnet 162 of follower magnet means 16 to ensure that follower magnet means 16 can be kept in the first position by the resulting magnetic force thereof.

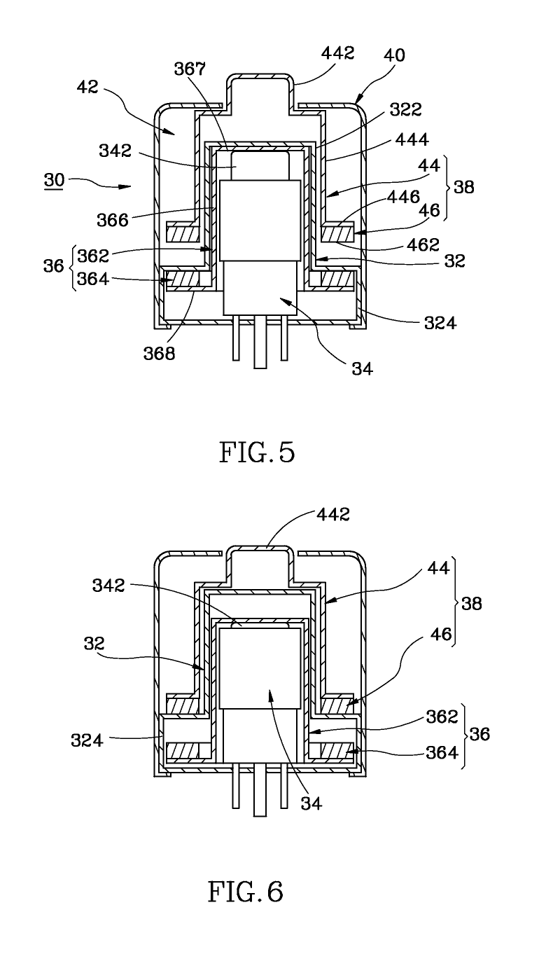

In a third embodiment of the present invention, as shown in FIGS. 5 and 6, a sealed magnetically controlled electric switch assembly 30 includes a sealable insulating housing 32, an electric switch 34, a follower magnet means 36, an active magnet means 38, and an insulating cover 40.

Housing 32 has a cylindrical portion 322 and a disc portion 324. Electric switch 34 and follower magnet means 36 are sealedly disposed in housing 32.

Electric switch 34 in this embodiment is also a conventional pushbutton switch for use in household electrical appliances. It is received in cylindrical portion 322 of housing 32 and has an on/off operating means (not shown in the drawings) with a pushbutton 342 being linearly operable to open and close switch contacts.

Follower magnet means 36 includes a frame 362 and an inner permanent magnet 364. Frame 362 has a cylindrical body 366 and an under brim 368. Electric switch 34 is received in cylindrical body 366 in such a way that pushbutton 342 of switch 34 leans against upper wall 367 of body 366 so that follower magnet means 36 and pushbutton 342 of switch 34 can move downward synchronously.

Inner permanent magnet 364 is ring-shaped and is attached to the upper surface of brim 368 of frame 362. As shown in the drawings, brim 368 and inner permanent magnet 364 both are received inside disc portion 324 of housing 32.

Insulating cover 40 is attached to insulating housing 32. In this embodiment, it is cylindrically shaped to provide a receiving room 42 to receive insulating housing 32, electric switch 34, follower magnet means 36, and active magnet means 38.

Active magnet means 38 has a frame 44 and an outer permanent magnet 46. Frame 44 has an upper push portion 442, a cylindrical portion 444, and an under brim 446. Outer permanent magnet 46 is attached to the undersurface of brim 446.

In combination, active magnet means 38 is positioned between the outside surface of cylindrical portion 322 of housing 32 and the inside surface of cover 40 in such a way that push portion 442 projects from an upper bore 402 of cover 40. Undersurface 462 of outer permanent magnet 46 faces upper surface 366 of inner permanent magnet 364 so that when push portion 442 of frame 44 is not in its depressed position, as shown in FIG. 5, the resulting magnetic force will cause active magnet means 38 and follower magnet means 36 to stay in a first position wherein electric switch 34 is in the off or open position.

When push portion 442 of frame 44 is depressed and thereby moved to a second position, as shown in FIG. 6, active magnet means 38 is simultaneously moved to lean against the upper surface of disc portion 324 of housing 32 so that the resulting magnetic force will cause follower magnet means 36 and pushbutton 342 of switch 34 to move downward synchronously, taking electric switch 34 from the off or open position to the on or closed position.

When the depression force on push portion 442 of frame 44 is released, on/off operating means of switch 34 will force pushbutton 342 thereof back to the off or open position; at the same time, follower magnet means 36 is moved synchronously with pushbutton 342 of switch 34, and the resulting magnetic force will cause active magnet means 38 back to the first position.

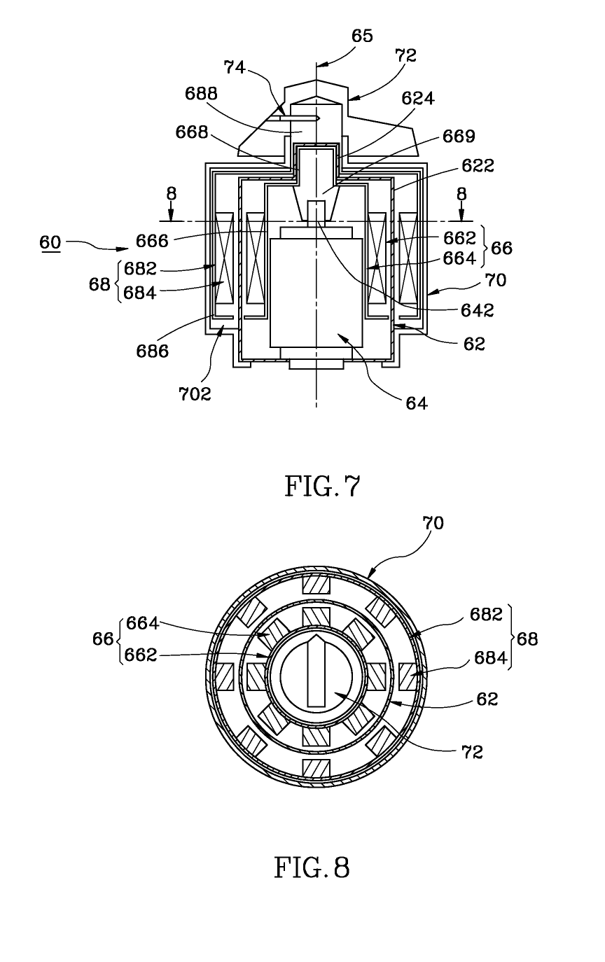

A fourth embodiment of the present invention is shown in to FIGS. 7 and 8. The structure shown therein is a sealed magnetically controlled electric switch assembly 60 that includes a sealable insulating housing 62, an electric switch 64, a follower magnet means 66, an active magnet means 68 and an insulating cover 70.

Insulating housing 62 has a cylindrical body 622 and a center shaft 624 projecting from the upper wall of body 622. Electric switch 64 is a rotary switch with an on/off operating means. The on/off operating means has a knob 642 that is switchable between the off or open position and the on or closed position by rotation about a rotary axis 65.

Follower magnet means 66 includes an inner frame 662 and one or more inner permanent magnets 664. Inner frame 662 has a cylindrical body 666, a first protrusion 668 extending from the upper wall of body 666, and a first couple portion 669 extending downward from the upper wall of body 666. Inner permanent magnet 664 is mounted on the outer surface of body 666 of inner frame 662. In this embodiment, the outer side of inner permanent magnet 664 has a particular magnetic polarity. First protrusion 668 of inner frame 662 is rotatably received in shaft 624 of housing 62, and first couple portion 669 couples with knob 642 of switch 64 so that knob 642 of switch 64 can rotate concurrently with follower magnet means 66.

Active magnet means 68 includes an outer frame 682 and one or more outer permanent magnets 684. Outer frame 682 has a cylindrical body 686 disposed around the outside of housing 62 and a center axle 688 rotatably coupled with center shaft 624 of housing 62 so that outer frame 682 can rotate about rotary axis 65.

Outer permanent magnet 684, in this embodiment has an outer side having a magnetic polarity that is opposite to the polarity of the outer side of inner permanent magnet 664. Outer permanent magnet 684 is mounted on the inner surface of body 686 of outer frame 682 in such a way that the outer side thereof faces the outer side of inner permanent magnet 664 so that the attractive magnetic forces will cause active magnet means 68 and follower magnet means 66 to stay in a first position.

Insulating cover 70 is cylindrically shaped and fixed on housing 62 in such a way that a space 702 is defined between the outer surface of housing 62 and the inner surface of cover 70 to receive active magnet means 68 therein. In this embodiment, sealed magnetically controlled electric switch assembly 60 further includes a handle 72 mounted on center axle 688 of outer frame 682 of active magnet means 68 by a pin 74 so that electric switch assembly 60 can be operated by handle 72.

In operation, when handle 72 is turned by users, active magnet means 68 is moved in the same direction as handle 72's turn. For example, when handle 72 is rotated a predetermined angle in the clockwise direction, active magnet means 68 is also moved clockwise. The attractive magnetic forces will cause follower magnet means 66 and on/off operating means of switch 64 to rotate synchronously with active magnet means 68 by the same number of degrees. As a result, switch 64 is switched from the off or open position to the on or closed position. When handle 72 is rotated counterclockwise, switch 64 will be switched back to the off or open position in the same manner.

What is claimed is:

1. A sealed magnetically controlled electric switch assembly, comprising:
an electric switch having an on/off operating means;
an active magnet means;
a follower magnet means; and
a sealable insulating housing;
said electric switch and said follower magnet means both being sealedly received in said housing in such a way that said on/off operating means of said switch is coupled with said follower magnet means for motion therewith; and
said active magnet means being disposed outside said housing in such a way that a resulting magnetic force is formed between said active magnet means and follower magnet means to switch said on/off operating means of said switch back and forth between on and off positions.

2. The switch assembly of claim 1, wherein said on/off operating means of said electric switch has a pushbutton being alternatingly movable in linear fashion between on and off positions.

3. The switch assembly of claim 2, wherein said switch has a central axis about which said on/off operating means of said switch, said active magnet means and said follower magnet are disposed.

4. The switch assembly of claim 3, wherein said housing has a cylindrical wall and a first receiving room; said electric switch and said follower magnet means are sealedly received in said room.

5. The switch assembly of claim 4, wherein said follower magnet means includes an inner permanent magnet; said wall of said housing has an upper portion; said inner permanent magnet is disposed sandwichedly between said upper portion of said wall of said housing and said pushbutton of said on/off operating means of said electric switch.

6. The switch assembly of claim 5, further comprising an insulating cover that has a cylindrical wall with a receiving room therein; said housing is partly received in said room to define a space to receive said active magnet means.

7. The switch assembly of claim 6, wherein said active magnet means includes an actuator and an outer permanent magnet fixed on said actuator.

8. The switch assembly of claim 7, wherein said actuator has a body and a pusher extending from one side of said body, said outer permanent magnet is fixed on another side of said body, said body and said outer permanent magnet are received in said space, and said pusher projects from said space to the outside of said cover.

9. The switch assembly of claim 8, wherein said inner permanent magnet and said outer permanent magnet are spaced out a predetermined distance and face each other with the same pole thereof such that the resulting magnetic force formed by them will cause said active magnet means and said follower magnet means to stay in a first position wherein said switch is kept in the off position; and when said actuator is depressed and thereby moved to a second position, the resulting magnetic force will cause said follower magnet means and said on/off operating means of said switch to move synchronously with said active magnet means from said first position to said second position wherein said switch is kept in the on position.

10. The switch assembly of claim 9, further comprising a first reinforced positioner made of paramagnetic materials and disposed on the internal wall of said insulating cover and near said inner permanent magnet of said follower magnet means so that said follower magnet means can certainly be kept in the first position when being unpushed.

11. The switch assembly of claim 9, further comprising a second reinforced positioner made of paramagnetic materials and disposed on the inner wall of said insulating cover and near said outer permanent magnet of said active magnet means to ensure that said active magnet means can be kept in the first position when the depression force is released.

12. The switch assembly of claim 3, wherein said housing has a
cylindrical portion and a disc portion; said electric switch is received in said center cylindrical portion of said housing; said follower magnet means includes an inner frame and an inner permanent magnet, said inner frame having a cylindrical body received in said cylindrical portion of said housing and an under brim received in said disk portion of said housing; said electric switch is covered by said cylindrical body of said frame in such a way that said pushbutton of said switch leans against the upper wall of said cylindrical body of said frame so that said follower magnet means and said pushbutton of said switch can move downward synchronously; said inner permanent magnet is attached to the upper surface of said under brim of said frame.

13. The switch assembly of claim 12, wherein said insulating cover is cylindrically shaped and attached to said insulating housing in such a way that a receiving room is defined therein to receive said insulating housing, said electric switch, said follower magnet means and said active magnet means.

14. The switch assembly of claim 13, wherein said active magnet means has an outer frame and an outer permanent magnet, said outer frame having an upper push portion, a cylindrical body portion and an under brim, and said outer permanent magnet is attached to the undersurface of said under brim; said outer frame of said active magnet means is disposed between the outside wall of said housing and the inside wall of said cover in such a way that said push portion projects from the upper side of said cover; said outer permanent magnet and said inner permanent magnet face each other with the same pole thereof and are spaced out a predetermined distance so that the resulting magnetic force formed by them will cause said active magnet means and said follower magnet means to stay in a first position wherein said electric switch is in the off or open position.

15. The switch assembly of claim 1, wherein said electric switch is a rotary switch with an on/off operating means, said on/off operating means having a knob that is switchable between the off or open position and the on or closed position by rotation about a rotary axis of said electric switch.

16. The switch assembly of claim 15, wherein said insulating housing has a cylindrical body and a center shaft projecting from the upper wall of said body.

17. The switch assembly of claim 16, wherein said follower magnet means includes an inner frame and an inner permanent magnet, said inner frame having a cylindrical body, a first protrusion extending from the upper wall of said body and a first couple portion extending downward from the upper wall of said body, and said inner permanent magnet is mounted on the outer surface of said body of said inner frame in such a way that the outer side thereof has a particular magnetic polarity; said first protrusion of said inner frame is rotatably received in said shaft of said housing, and said first couple portion of said inner frame couples with said knob of said switch.

18. The switch assembly of claim 17, wherein said active magnet means includes an outer frame and an outer permanent magnet having an outer side with a magnetic polarity that is opposite to the polarity of the outer side of said inner permanent magnet, said outer frame having a cylindrical body disposed around the housing and a center axle rotatably coupled with said center shaft of said housing so that said outer frame can rotate about the rotary axis of said electric switch, and said outer permanent magnet is mounted on the inner surface of said body of said outer frame in such a way that the outer side thereof faces the outer side of said inner permanent magnet so that the resulting magnetic force formed therebetween will cause said active magnet means and said follower magnet means to stay in the same position.

19. The switch assembly of claim 18, further comprising an insulating cover being cylindrically shaped and fixed on said housing in such a way that a space is defined between the outer surface of said housing and the inner surface of said cover to receive said active magnet means therein.
